(19) United States
(12) Patent Application Publication
(10) Pub. No.: US 2025/0383276 A1
(43) Pub. Date: Dec. 18, 2025

(54) SPRING-ACTUATED UNIVERSAL IMPACT TEST DEVICE

(71) Applicant: ISTANBUL TEKNIK UNIVERSITESI, Istanbul (TR)

(72) Inventors: Ali SARI, Istanbul (TR); Mesut KUCUK, Istanbul (TR)

(73) Assignee: ISTANBUL TEKNIK UNIVERSITESI, Istanbul (TR)

(21) Appl. No.: 18/878,135

(22) PCT Filed: Jun. 21, 2023
(86) PCT No.: PCT/TR2023/050604

§ 371 Date: Dec. 23, 2024

(30) Foreign Application Priority Data
Jun. 22, 2022 (TR) 2022/010390

(51) Int. Cl. G01N 3/307; G01N 3/06

(52) U.S. Cl. CPC G01N 3/307; G01N 3/06; G01N 2203/0676

(57) ABSTRACT

The provided is a test device for testing the horizontal impact effects of various materials such as ceramics, metals, plastics, composites or various elements made of these materials. The test device includes an impact trolley, a spring-loaded launching system, a hook and spring tensioning system, a spring tensioning distance adjustment and unhooking system, an impact absorber system, derailment barriers, a specimen main mounting frame, and an anti-kickback apparatus.

### CROSS-REFERENCE TO THE RELATED APPLICATIONS

This application is the national phase entry of International Application No. PCT/TR2023/050604, filed on Jun. 21, 2023, which is based upon and claims priority to Turkish Patent Application No. 2022/010390, filed on Jun. 22, 2022, the entire contents of which are incorporated herein by reference.

### TECHNICAL FIELD

The invention relates to a test device for impact testing of various materials such as ceramics, metals, plastics, composites or various elements made of these materials.

### BACKGROUND

Impact tests are short-term applications that provide information about the fracture behavior of materials or parts under rapidly applied load. Impact tests are performed on materials such as ceramics, metals, plastics, composites, etc. Thus, information is obtained about the material's resistance to impacts. As a result, it is ensured that the appropriate material is used in the appropriate field.

Impact tests are frequently used in defense industry, oil and gas industry, chemical and nuclear facilities, impact and explosion engineering, construction and building sector, machinery-manufacturing sector, aviation sector, automotive sector and R&D laboratories of universities.

Many test methods are used to measure the behavior of a material or an element made of certain materials under impact.

### Impact Technique With Pendulum Strike

In this technique, the impact effect occurs when a certain weight is suspended from a certain height with a rope or a rod to which it is attached, reaches a certain speed and hits the targeted sample at this speed.

### Impact Technique With Weight Drop

In this technique, the impact effect occurs as a result of a certain weight being released from a certain height in a certain guide system, reaching a certain speed and hitting the targeted sample with this speed.

### Compressed Air Impact Technique

In this technique, the impact effect occurs when the compressed air is suddenly released in a certain channel and throws the weight with the force applied to a certain weight placed in the channel and the weight hits the specimen with the speed reached by the weight.

### Hydraulic Actuator Impact Technology

In this technique, the impact effect occurs when a hydraulic system, operating at certain frequencies, directly or as a result of the force applied to a certain weight, the weight hits the sample at a certain speed.

### Spring-Loaded Actuator Impact Technique

In this technique, the impact effect occurs as a result of throwing a certain weight with a spring by stretching and releasing it at a certain level and hitting the sample with the speed reached by the weight.

However, the mentioned impact test techniques have some disadvantages. Some of these disadvantages can be listed as follows;

It has been observed that there are deficiencies in technical issues such as:
Limited solution generating capability in terms of impact load and bracing,
Ability to test uniform specimens,
In some cases, data such as load-time, acceleration-time, velocity cannot be collected,
Not suitable for free collision scenarios where the forcing effects of gravity etc. are eliminated,
Unsuitability of methods for both material and element or system tests,
Lack of specimen mounting capabilities in many different positions,
Limitations on combinations of weight-velocity-collision surface geometry and stiffness.

The Chinese utility model document CN203732351U in the known state of the art mentions a shaft-type torsional impact fatigue test device comprising an impact hydraulic cylinder, a support plate, an impact hammer, an elastic cushion, a torsion arm, a straight key, a drive shaft, a bearing, a left fixed base, a torque sensor, an end cap, a left clamp, a bearing sleeve mounted on the left clamp with flange, a bearing, a right fixed base, a screw rod seat, a guide rail, a guide rail seat, a screw rod, a handle, a sliding base, a support sleeve, a bolt, a spring, a right clamp, a test specimen and a flat wrench.

The Canadian patent document CA2399499A1, which is in the known state of the art, mentions a multi-purpose test system for delivering a certain amount of mechanical energy to a specimen. It is a two-trolley compression specimen testing system. A collision occurs. The trolleys move by gravity on the same oppositely inclined rails that converge on the horizontal segments where the collision occurs. This allows the kinetic energy of the trolleys to be transmitted to a compression specimen carried by one of the trolleys. The drop height and the mass of the trolley affect the impact energy. The kinetic energy of the trolleys is partially transmitted to the test specimen. The specimen fracture energy is determined by measuring the initial and final height of the center of mass of each trolley. The striker includes lower trolley, upper trolley, lower track, upper part, straight rail segment, left curved rail segment, right curved rail segment, plate, plain mold, pocket mold, funnel, calorimeter, recess and holder.

The Chinese patent document CN105092395A, which is in the known state of the art, mentions systems comprising a horizontal impact test stand. The system consists of a load carrying platform, two slide supports, multiple horizontal slide rails, suspension systems and mounting clamp. It includes U-type profiles and hooks.

In the United States patent document numbered U.S. Pat. No. 2,630,704A, which is in the known state of the art, a test system using a ball screw is mentioned in order to adjust the path it will take under the influence of springs to accelerate a trolley.

In the Spanish patent document numbered ES2606331A1, which is in the known state of the art, a horizontal test system stretched with the help of a pulley is mentioned. A hook used to release the tensioned structure is also described.

In the United States patent document numbered US1106747474B2, which is in the known state of the art, a system including a hook that interacts with the threads on a control rail and provides both the adjustment of the distance to be used for acceleration and the release of the system and the installation method of this system is mentioned.

Differences of the mentioned developed spring-actuated universal impact test device from other spring-actuated impact devices are listed as:
Easy installation of the device
Solutions for tensioning and releasing the spring at a certain distance,
Easy rearrangement of the impact trolley in terms of weight and mechanical properties
Easy organization of the specimen assembly according to the user's request
Measuring instruments and cables to be used for collecting experimental data are well designed in terms of location and use on the device.

However, the sample patent documents do not include hooks and a bearing structure that releases the knob by compressing these hooks in order to trigger the impact. In addition, the developed spring-actuated universal impact test device provides convenience to the user with advantages such as setting up the springs, tensioning and throwing the weight, applying impact by impacting the weight to the targeted object in predictable and different ways, and measuring the applied impact effects. Therefore, the need for the development of the inventive spring-actuated universal impact test device was felt.

### SUMMARY

It is an object of the present invention to provide a spring-actuated universal impact test device to facilitate the assembly of the specimen to be tested and to allow the use of various specimens.

Another object of the present invention is the realization of a spring-actuated universal impact test device which allows the impact weight to be easily increased or decreased as desired by the user.

Another object of the present invention is to realize a spring-actuated universal impact test device which allows the impact contact surface to be easily changed.

Another object of the present invention is to provide a spring-actuated universal impact test device, which allows the springs to be easily changed according to the test program.

It is another object of the present invention to provide a spring-actuated universal impact test device for providing impact in the horizontal plane, eliminating forcing effects such as gravity and providing a free collision with the specimen.

It is another object of the present invention to provide a spring-actuated universal impact test device, which allows the measurement sensors such as load, acceleration and speed to be easily changed according to the test program.

Another object of the present invention is the realization of a spring-actuated universal impact test device, which allows the installation or installation location of the device to be easily changed when desired.

### BRIEF DESCRIPTION OF THE DRAWINGS

The spring-actuated universal impact test device for achieving the objects of the present invention is shown in the accompanying figures.

These figures;

FIG. 1: Perspective view of a spring-actuated universal impact test device.

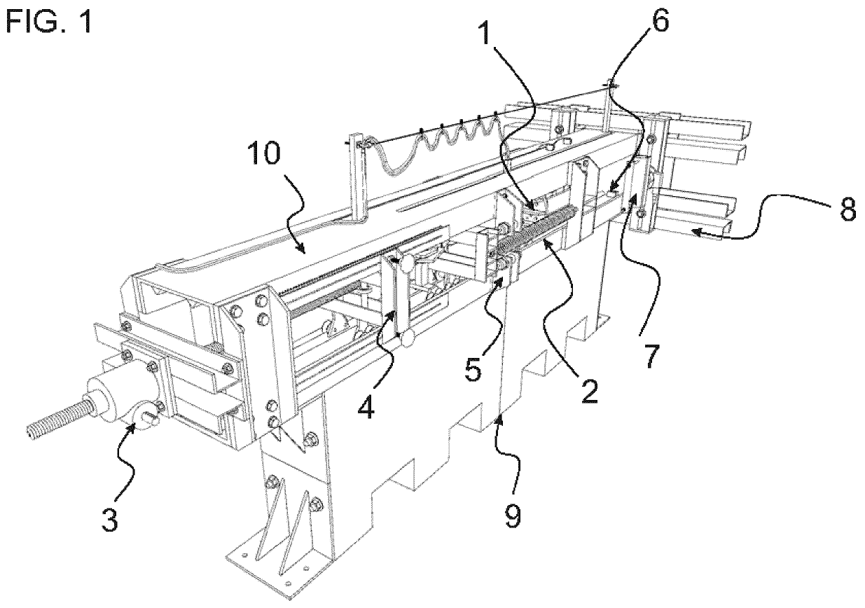

FIG. 2: Front view of the spring-actuated universal impact test device.

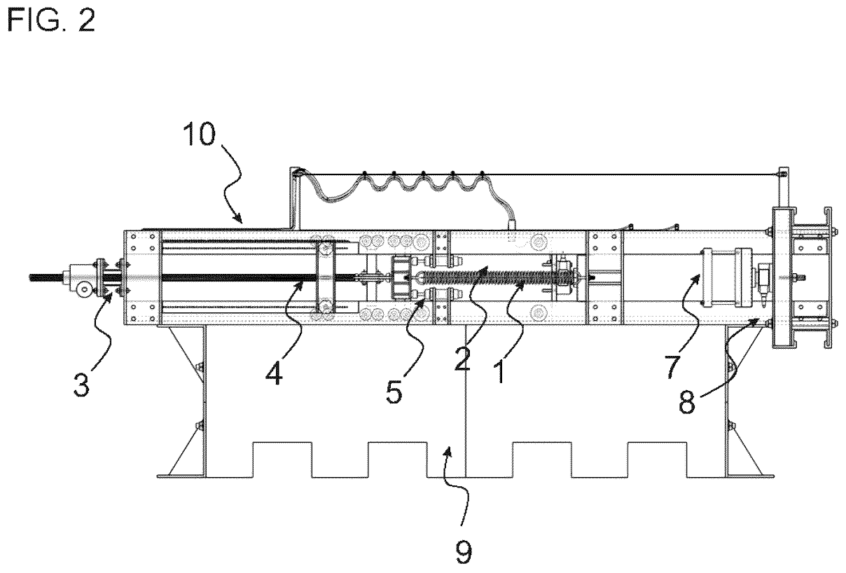

FIG. 3: Perspective view of the impact trolley.

FIG. 4: Side view of the impact trolley.

FIG. 5: Front view of the impact trolley.

FIG. 6: Top view of the impact trolley.

FIG. 7: Perspective view of the spring-loaded launch system.

FIG. 8: Perspective view of the spring-loaded launch system on the test device.

FIG. 9: Top view of the spring-loaded launch system.

FIG. 10: Perspective view of the hook and spring tensioning system.

FIG. 11: Perspective view of the spring tensioning distance adjustment and unhooking system.

FIG. 12: Perspective view of the spring tensioning distance adjustment and unhooking system on the test device.

FIG. 13: Perspective view of the shock absorber system.

FIG. 14: Side view of the shock absorber system on the test device.

FIG. 15: Perspective view of the shock absorber system on the test device.

FIG. 16: Perspective view of derailment barrier.

FIG. 17: Side view of the derailment barrier on the test device.

FIG. 18: Perspective view of the derailment barrier on the test device.

FIG. 19: Perspective view of the specimen main mounting frame.

FIG. 20: Perspective view of the specimen main mounting frame on the test device.

FIG. 21: Perspective view of the three-point loading system.

FIG. 22: Top view of the three-point loading system on the test device.

FIG. 23: Perspective view of the anti-kickback apparatus.

FIG. 24: Perspective view of the linear motion frame.

FIG. 25: Front view of the linear motion frame.

FIG. 26: Side view of the linear motion frame.

The parts in the figures are numbered one by one and the equivalents of these numbers are given below.
1. Impact trolley
   1.1. Load sensor connection flange
   1.2. Hook holding knob
   1.3. Weight attachment holes
   1.4. Impact rail wheels
   1.5. Control lever and cable carrying box
   1.6. Load sensor
   1.7. Acceleration sensor
2. Spring-loaded launching system
   2.1. Tension springs
   2.2. Push trolley
   2.3. Connecting beam
   2.4. Launching rail wheels
3. Hook and spring tensioning system
   3.1. Screw jack
   3.2. Release hook
   3.3. Connecting beams
   3.4. Tensioning rail wheels
   3.5. Jack connection beams
   3.6. Electric motor
   3.7. Closing spring
4. Spring tensioning distance adjustment and unhooking system
   4.1. Bearing
   4.2. Vertical circular bar
   4.3. Clamping knobs
   4.4. Distance ruler
   4.5. Unhooking rail wheels
   4.6. Fixing frame
5. Shock absorber system
   5.1. Shock absorber
   5.2. Fasteners
6. Derailment barrier
   6.1. Fixing element
   6.2. Energy absorbing element
7. Specimen main mounting frame
   7.1. Long U-section profile
   7.2. Short U-section profile
8. Three-point loading system
   8.1. Cylindrical support
   8.2. Cylindrical clamping element
   8.3. Sliding beam
   8.4. Load sensors
   8.5. Loading element
9. Anti-kickback apparatus
   9.1. Weight block
   9.2. Brackets
10. Linear motion frame
   10.1. Distance sensor
   10.2. Wheel rails
   10.3. Fasteners
   10.4. Distance adjustment ruler
   10.5. Connection point
   10.6. Cable carrying apparatus

### DETAILED DESCRIPTION OF THE EMBODIMENTS

The developed impact test device includes;
an impact trolley (1), which is the weight to which the impact load is provided, to which sensors such as acceleration and load in the test device can be connected,
a load sensor connection flange (1.1) on the impact trolley (1), used for load sensor connection,
a hook holding knob (1.2) on the impact trolley (1), which allows the hook to be attached,
weight attachment holes (1.3) on the impact trolley (1), allowing the use of impact trolleys (1) with different weights,
impact rail wheels (1.4) on the impact trolley (1), providing linear movement,
cocking handle and cable carrying box (1.5) on the impact trolley (1),
a load sensor (1.6) on the impact trolley (1), which provides parameters of impact contact surface geometry and stiffness by connecting materials of different geometry and elastic properties,
an acceleration sensor (1.7) on the impact trolley (1) for setting the acceleration parameter,
spring-loaded launching system (2) to provide the launching task in the test device
two tension springs (2.1) on the right and left side of the impact trolley (1), belonging to the spring-loaded launching system (2), which can be changed according to the experimental program, where the energy will be stored,
a push trolley (2.2) to move on rails, connected to two tension springs (2.1),
two connecting beams (2.3) of the spring-loaded launching system (2) connected to two tension springs (2.1),
launching rail wheels (2.4) on the push trolley (2.2), which will transfer the energy from the tension spring to the impact trolley,
a hook and spring tensioning system (3) connected to the impact trolley (1) and allowing the impact trolley (1) to be tensioned with springs
a screw jack (3.1) that can be used for spring tensioning of the hook and spring tensioning system (3),
a quick-release hook (3.2) of the hook and spring tensioning system (3) to hold the hook holding knob (1.2) of the impact trolley (1) in connection with the push trolley (2.2) of the spring-loaded launching system (2),
jack connecting beams (3.3) connected to the screw jack (3.1), which will allow the screw jack (3.1) to be connected to the beams and the hook and spring tensioning system (3) to be connected to the linear motion frame,
tensioning rail wheels (3.4) to allow the hook connected to the release hook (3.2) to move within the linear motion frame,
jack connection beams (3.5) to connect the screw jack (3.1) to the connecting beams (3.3),
an electric motor (3.6) connected to the screw jack (3.1), which will be used for spring tensioning,
closing spring (3.7), which compresses the release hook (3.2) to hold the hook holding knob (1.2),
a spring tensioning distance adjustment and unhooking system (4) for adjusting the tensioning distance of the tension springs (2.1) and for opening the release hook (3.2) at this distance and releasing the impact trolley (1)
two bearings (4.1) belonging to the spring tensioning distance adjustment and unhooking system (4),
two vertical circular bars (4.2) connected to the bearings (4.1) and on which the bearings (4.1) are fixed,
unhooking rail wheels (4.5) providing linear movement to which vertical circular bars (4.2) are connected,
a fixing frame (4.6) that can move within the linear motion frame,
a distance ruler (4.4) attached to the fixing frame (4.6),
clamping knobs (4.3) that attach the fixing frame (4.6) to the distance ruler (4.4),
shock absorbing system (5), which stops the push trolley (2.2) pushing the impact trolley (1) so that it leaves the impact trolley (1) after a certain distance,
four shock absorbers (5.1) to stop the push trolley (2.2),
fasteners (5.2) for fixing the shock absorbers (5.1) to the motion system,
a derailment barrier (6) to prevent derailment,
a fixing element (6.1) for the derailment barrier (6),
an energy absorbing element (6.2) located in front of the fixing element (6.1), which breaks the energy by deformation or damage,
a specimen main mounting frame (7) to allow the specimens to be connected to the test device in various ways,
two long U-section profiles (7.1) to fix the specimen main mounting frame (7) to the bottom and sides of the linear motion frame,
four short U-section profiles (7.2) to fix the specimen main mounting frame (7) to the bottom and sides of the linear motion frame,
two cylindrical supports (8.1) of the three-point loading system (8) connected to the specimen main mounting frame (7),
a cylindrical clamping element (8.2) used to fix the specimens on the cylindrical support (8.1),
two sliding beams (8.3) of the three-point loading system (8) connected to the specimen main mounting frame (7),
load sensors (8.4) of the three-point loading system (8) connected to the specimen main mounting frame (7),
two cylindrical loading elements (8.5) of the three-point loading system (8) connected to the specimen main mounting frame (7),
anti-kickback apparatus (9) used to stabilize the test device and prevent kickback during operation,
weight block (9.1) belonging to the anti-kickback apparatus (9),
brackets (9.2) of the anti-kickback apparatus (9),
a linear motion frame (10) that allows the impact to move in one direction and compensates for the force of the spring as it is tensioned,
a distance sensor (10.1) located in the linear motion frame (10) and used for speed measurement,
wheel rails (10.2) for the movement of the rail wheels,
fasteners (10.3) that allow the linear motion frame (10) to be integrated into each other,
a distance adjustment ruler (10.4) used for adjusting the tensioning distance for tension springs (2.1),
a connection point (10.5), which allows the linear motion frame (10) to be integrated together,
a cable carrying apparatus (10.6) used for the load sensor (1.6) and acceleration sensor (1.7) on the linear motion frame (10).

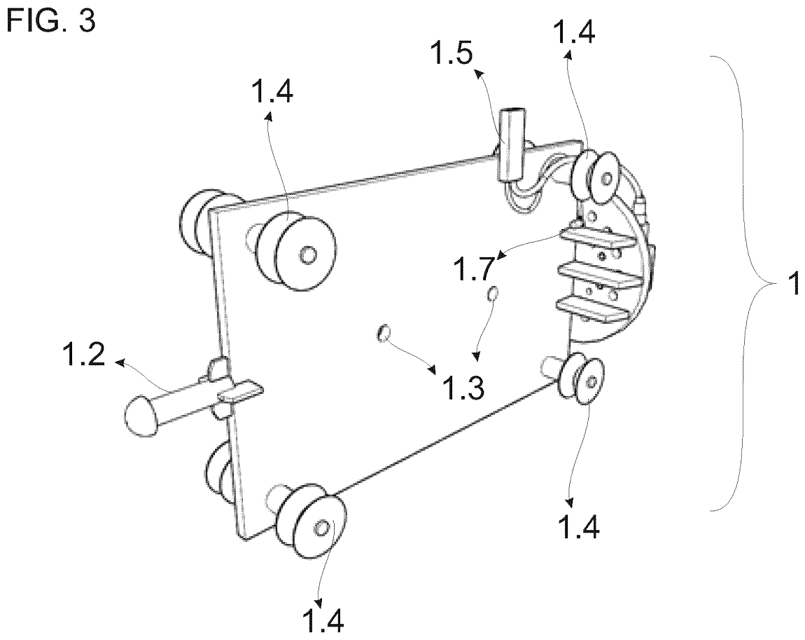

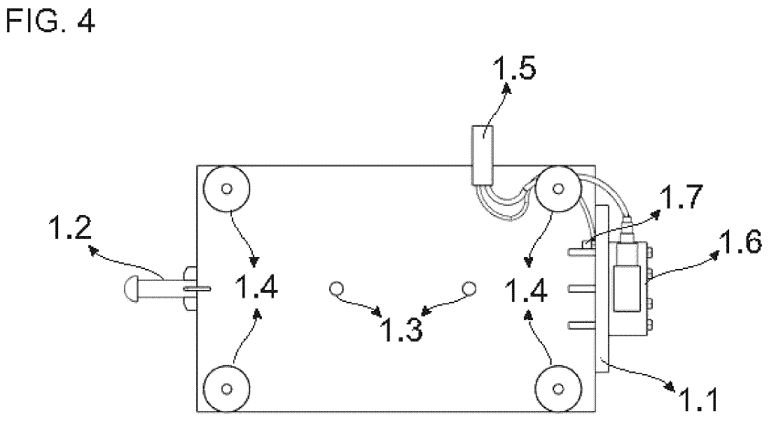

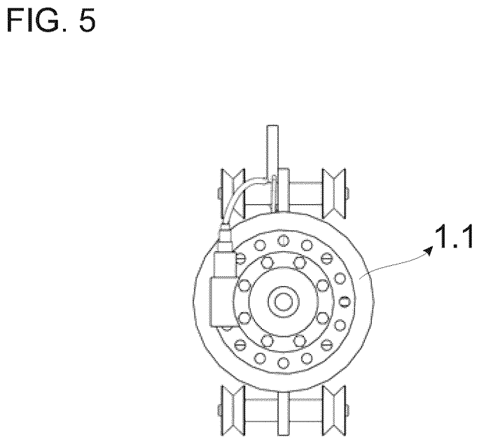

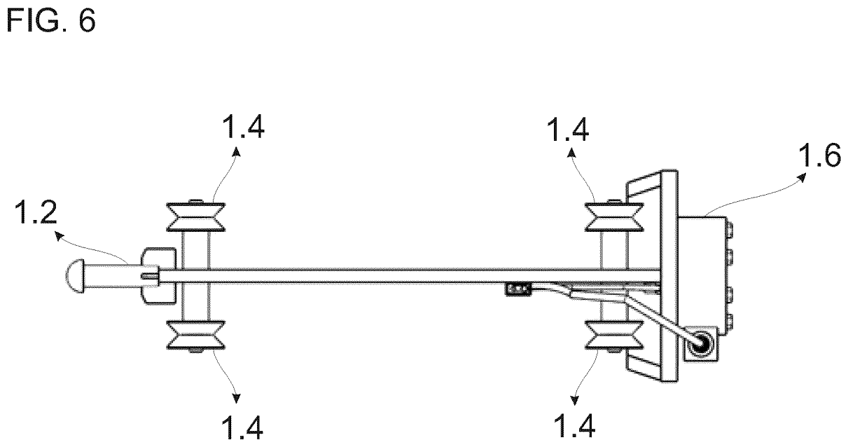

FIG. 3, FIG. 4, FIG. 5 and FIG. 6 show the impact trolley (1). The impact trolley (1) consists of weight attachment holes (1.3), load sensor connection flange (1.1), user-usable crown and cable carrying box (1.6), hook holding knob (1.2), impact rail wheels (1.4), load sensor (1.6), acceleration sensor (1.7).

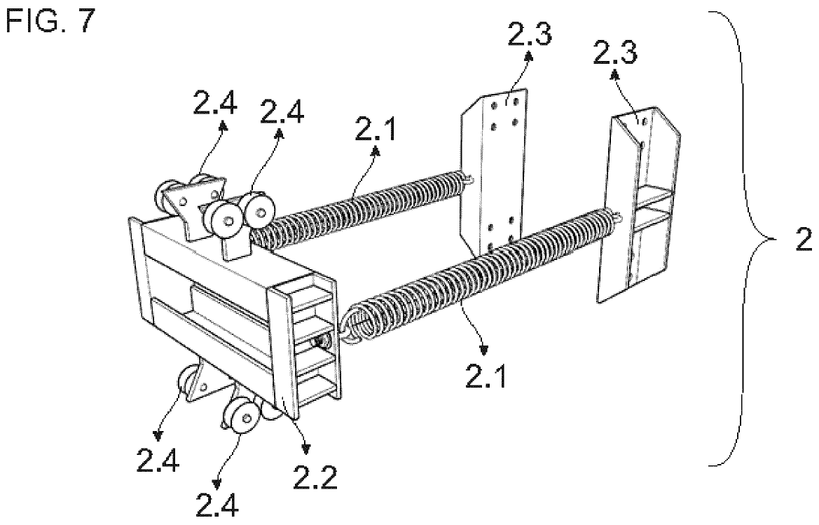

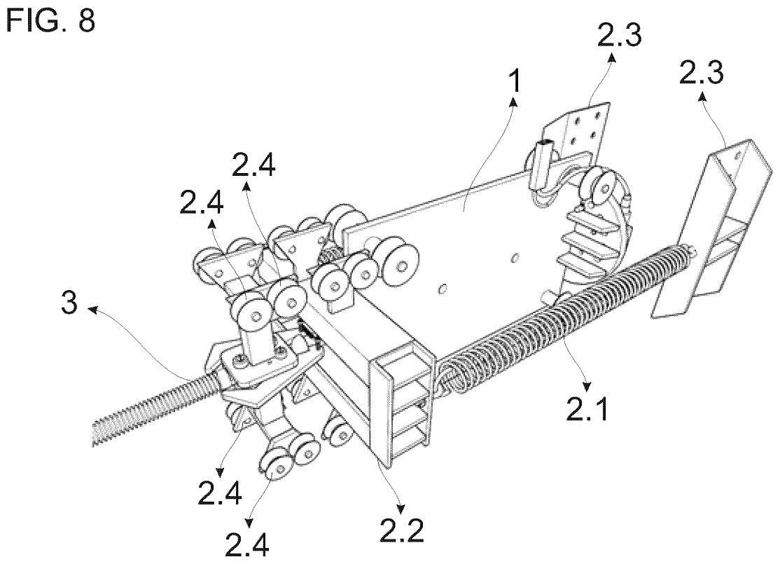

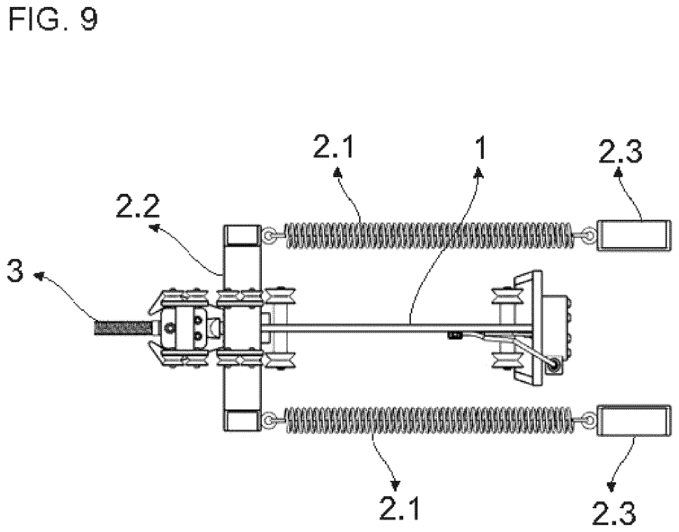

In order to apply (1/2)×m×v² impacts at a given velocity (v) and energy (1/(2))×m×v2 with the impact trolley (1), the spring-loaded launch system (2) shown in FIG. 7, FIG. 8 and FIG. 9 is used.

The spring-loaded launching system (2) consists of two tension springs (2.1) to store the energy, launching rail wheels (2.4) to transfer the energy in the tension springs (2.1) to the impact trolley (1), the push trolley (2.2) to move on the rails in the linear motion frame (10) and the connecting beam (2.3) to connect the spring-loaded launching system (2) to the linear motion frame (10). In order for the impact trolley (1) to be launched by means of the spring-loaded launching system (2), the traction springs (2.1) must be tensioned together with the impact trolley (1).

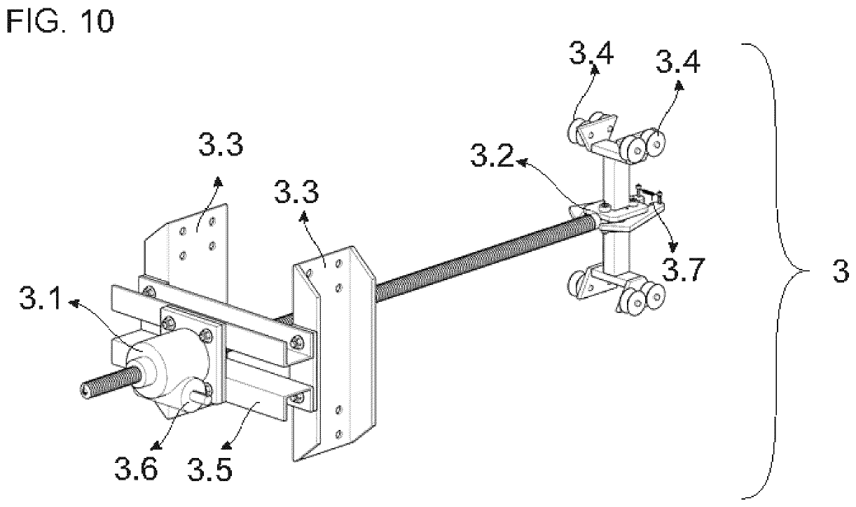

The hook and spring tensioning system (3) shown in FIG. 10 is used for spring tensioning and launching. The hook and spring tensioning system (3) consists of a quick release hook (3.2) to hold the hook holding knob (1.2) on the impact trolley (1), a screw jack (3.1) that can be used for spring tensioning by connecting an electric motor (3.6), tensioning rail wheels (3. 2) consists of tensioning rail wheels (3.4) to allow the release hook (3.2) to move in the linear motion frame (10), connecting beams (3.3) to connect the hook and spring tensioning system (3) to the linear motion frame (10), and jack connection beams (3.5) to connect the screw jack (3.1) to these beams.

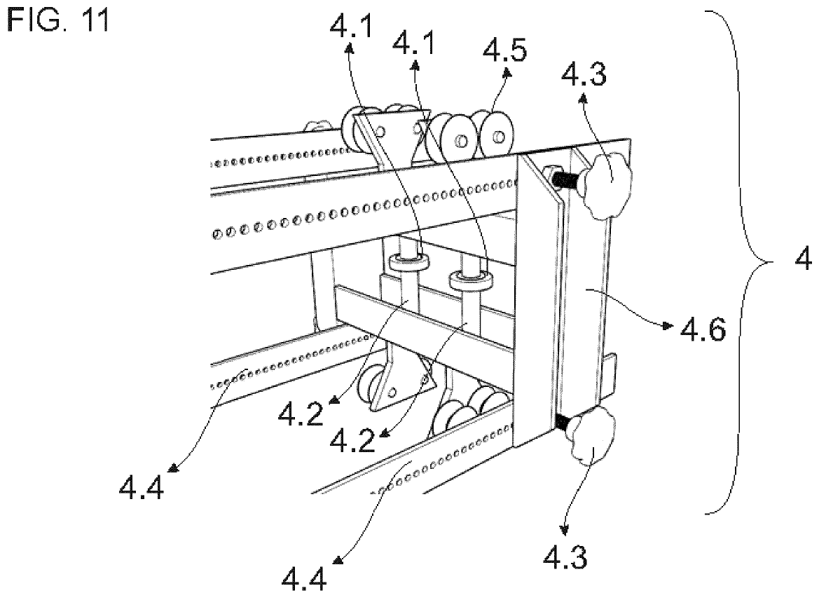

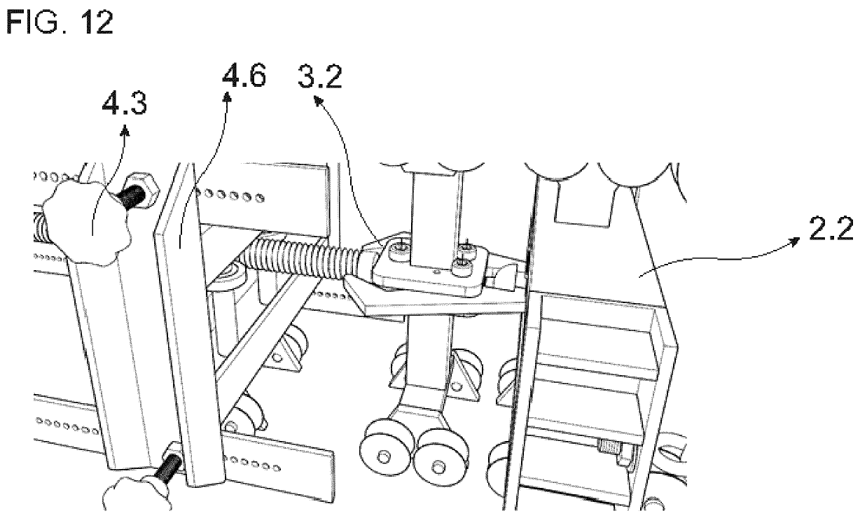

The spring tensioning distance adjustment and unhooking system (4) shown in FIGS. 11 and 12 is used to tension the traction springs (2.1) to a certain distance, after which the push trolley (2.2) and impact trolley (1) in the spring-loaded launching system (2) can be released and start moving. This spring tension adjustment and unhooking system (4) consists of two horizontal bearings (4.1) at a certain distance, two vertical circular bars (4.2) to which these bearings (4.1) are fixed, these vertical circular bars (4. 2) are connected to the fixing frame (4.6), which is movable in the linear motion frame (10) by means of the unhooking rail wheels (4.5), and the clamping knobs (4.3) that attach the fixing frame (4.6) to the distance ruler (4.4). The quick-release hooks (3.2) start to open at the moment of contact with the bearings (4.1) fixed at a certain distance and in a short time the quick-release hooks (3.2) are separated from the hook holding knob (1.2) and the impact trolley (1) is launched by the spring-loaded launching system (2).

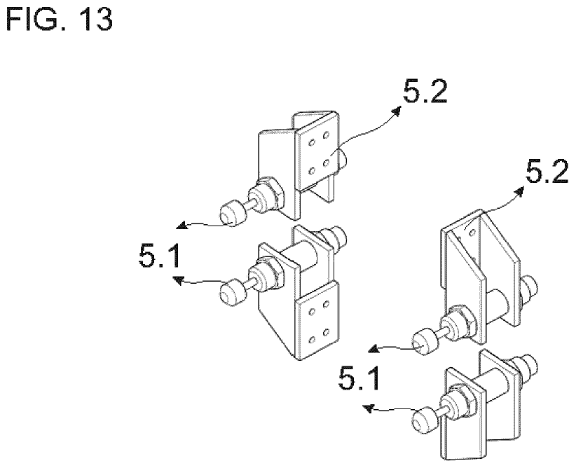

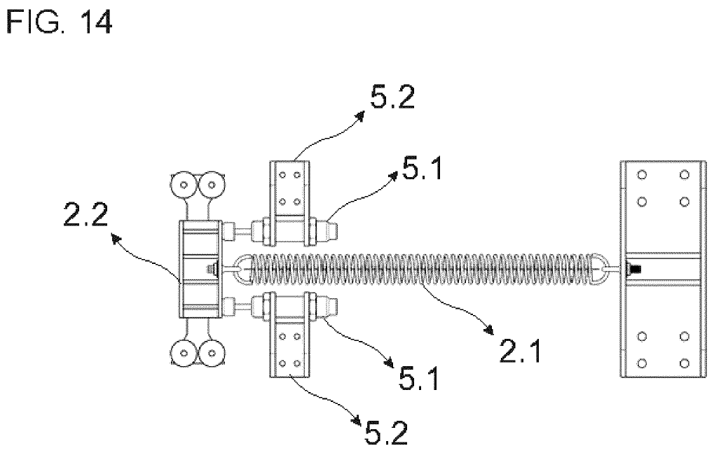

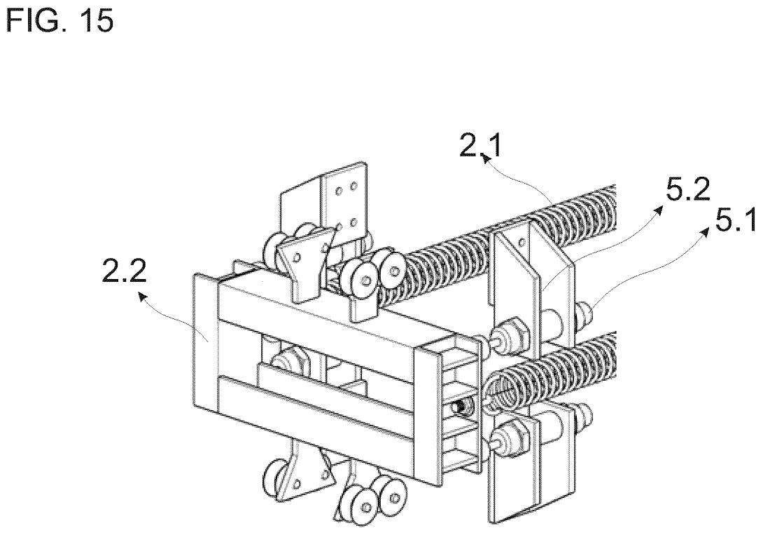

During the pushing of the impact trolley (1) with the spring-loaded launching system (2), the push trolley (2.2) in the spring-loaded launching system (2) must be stopped so that the energy in the spring is transferred to the impact trolley (1) and the impact trolley (1) can move on its own after a certain point. It is provided by the shock absorber system (5) in the spring-loaded launching system (2) shown in FIGS. 13, 14 and 15. The impact absorber system (5) consists of four impact absorbers (5.1) and fasteners (5.2) to fix them to the linear motion system (10). At the distance at which the push trolley (2.2) is to be separated from the impact trolley (1), the push trolley (1) is stopped by these four impact absorbers (5.1) without damage. After the impact trolley (1) leaves the push trolley (2.2), it moves freely in the linear motion frame (10) towards the specimen to be tested and applies impact.

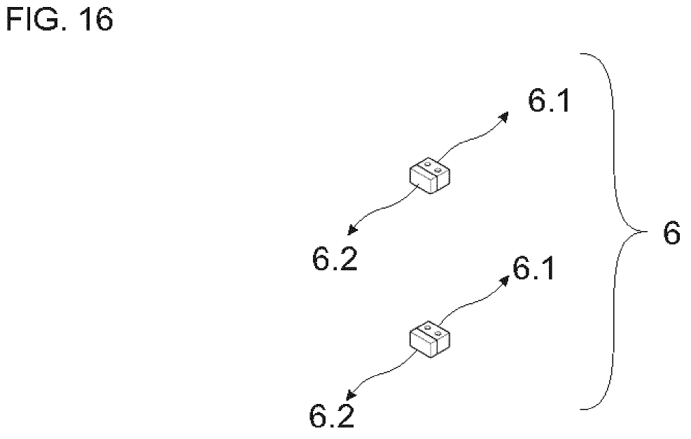

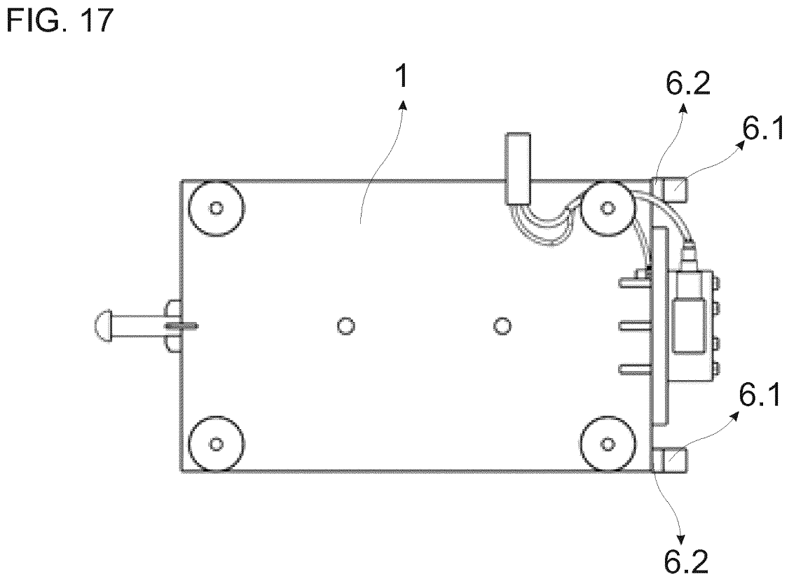

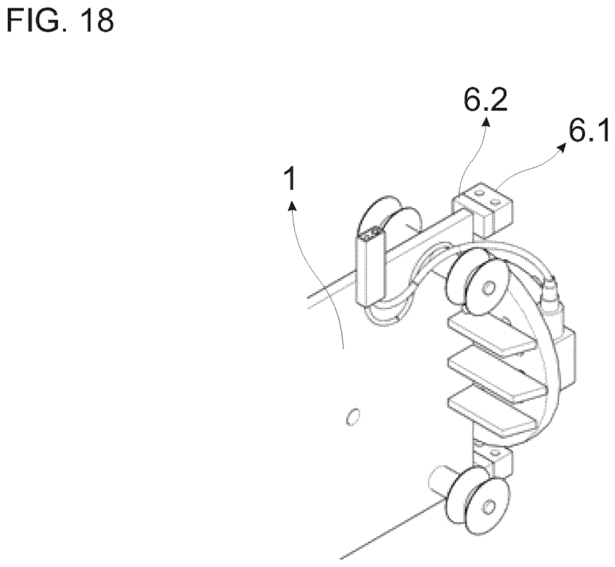

After the impact is applied to the test specimen, the derailment barrier (6) as shown in FIGS. 16, 17 and 18 is used to prevent the impact trolley (1) from passing the specimen and leaving the linear motion frame (10). These derailment barriers (6) are used as fixing element (6.1) to the linear motion frame (10) and energy absorbing element (6.2) is used in front of this fixing element (6.1) by large deformation or damage. If the impact trolley (1) continues by damaging the specimen, the impact trolley (1) will hit the energy absorbing element (6.2) and lose most of its energy and stop.

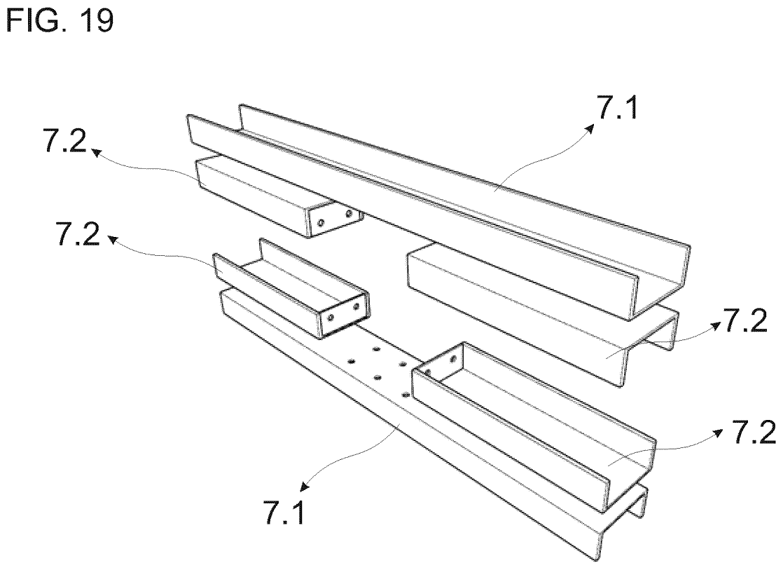

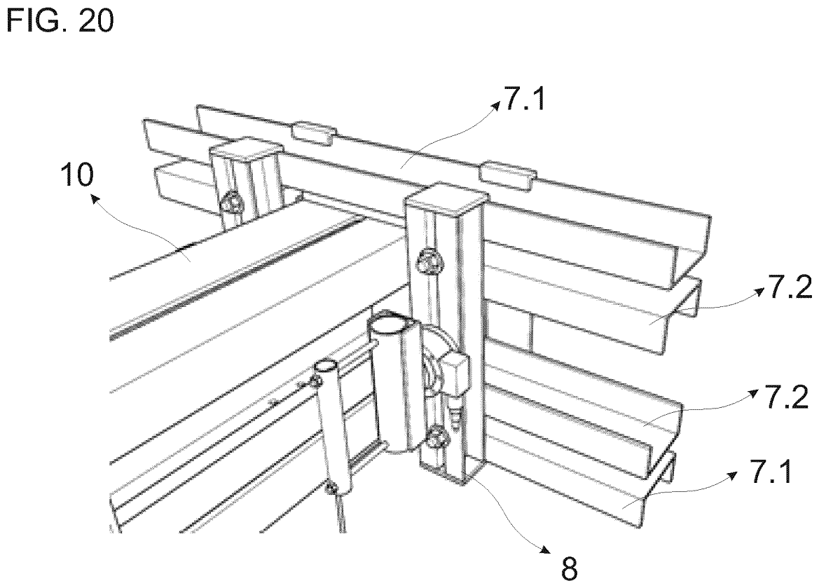

A specimen main mounting frame (7) as shown in FIG. 19 and FIG. 20 is used for fixing the specimens to the test device. This specimen main mounting frame (7) consists of two long U-section profiles (7.1) and four short U-section profiles (7.2) for fixing underneath and on the sides of the linear motion frame (10), respectively. Thanks to the gaps formed after the installation of this assembly, the specimens can be fixed to the specimen main mounting frame (7) easily and in many ways with the specimen main mounting frame (7) to be adapted by the practitioner and the test can be carried out.

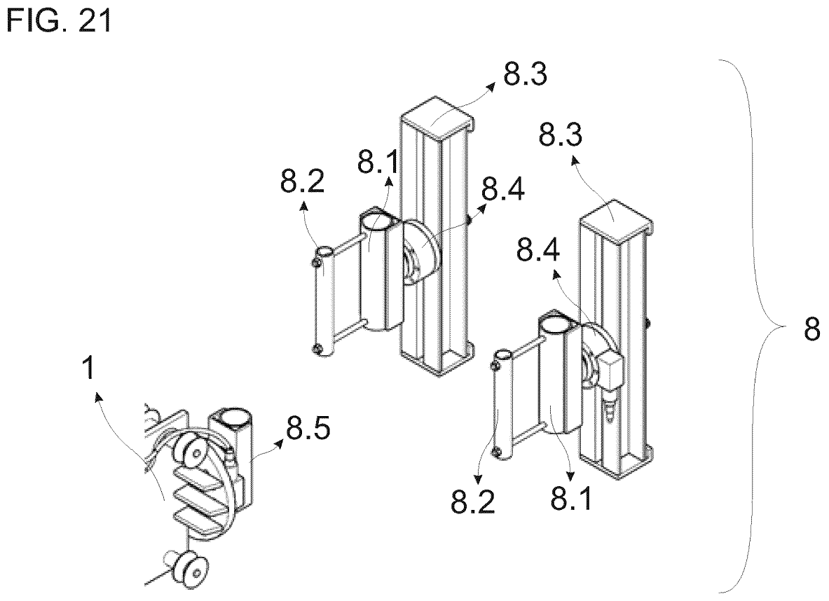

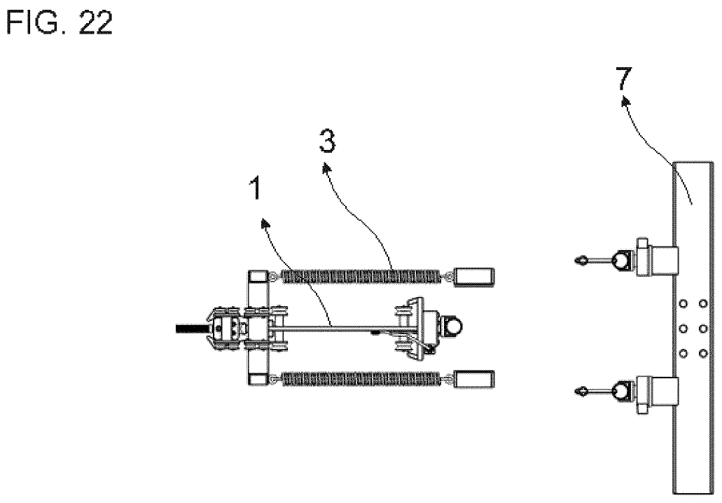

For example, if a three-point test is to be performed, a three-point loading system (8) can be connected to the specimen main mounting frame (7) as shown in FIGS. 21 and 22. This three-point loading system (8) consists of two sliding beams (8.3), two cylindrical supports (8.1) and load sensors (8.4) between these cylindrical supports (8.1) and the sliding beam (8.3) and one loading element (8.5) connected to the impact trolley (1). Thanks to the sliding beams (8.3), tests can be performed at the desired span of the cylindrical support (8.1). Cylindrical clamping elements (8.2) are used to fix the specimens on the cylindrical support (8.1). The cylindrical loading element (8.5) is connected to the load sensor (1.6) connected to the impact trolley (1).

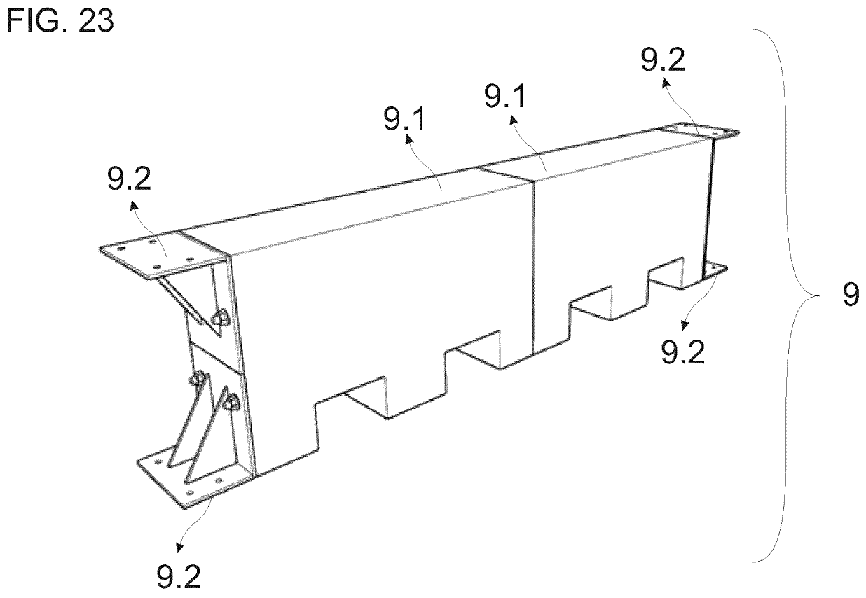

In order to prevent movement outside the impact trolley (1) during the launching of the impact trolley (1) with the spring-loaded launching system (2), the anti-kickback apparatus (9) shown in FIG. 23 is used. This anti-kickback apparatus (9) consists of two weight blocks (9.1) that can be transported by pallet truck, four studs connecting the weight blocks (9.1), brackets (9.2) for mounting the linear motion frame (10) with the weight blocks (9.1) and the ground.

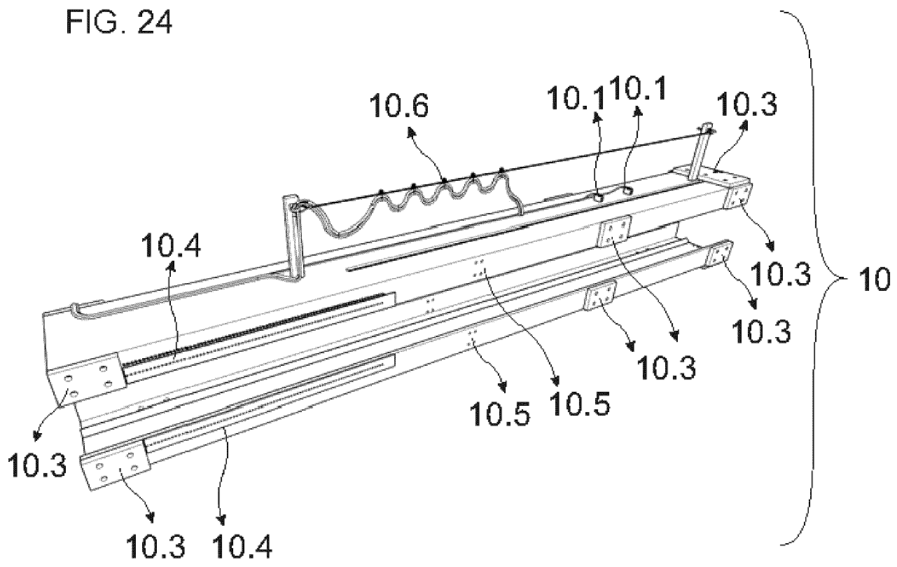

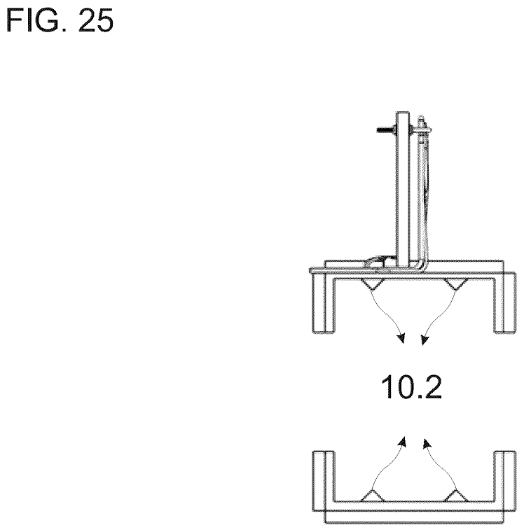

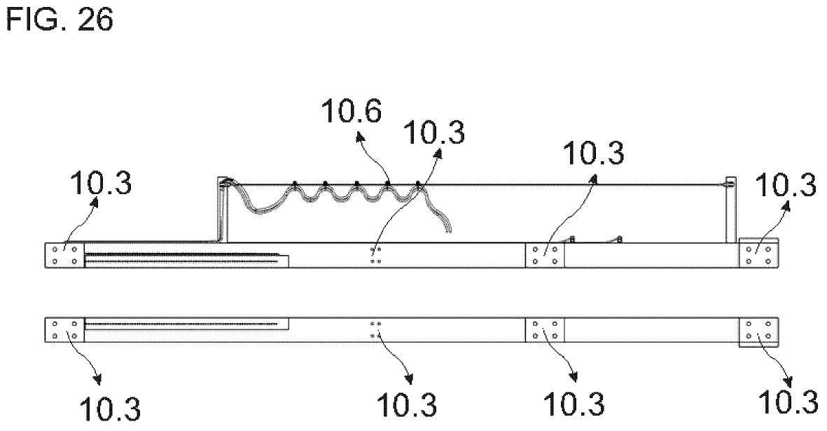

The linear motion frame (10) shown in FIGS. 24, 25 and 26 consists of two U-section profiles, wheel rails for bearing the moving components (10.2), spring launching system (2) fasteners (10.3), hook and spring tensioning system (3) fasteners (10.3), spring tensioning distance adjustment ruler (10. 4), impact absorbing system (5) connection point (10.5), derailment barrier (6) connection point, specimen main mounting frame (7) connection elements, anti-kickback (9) connection points, cable carrying apparatus for load sensor (1.6) and acceleration sensor (1.7) (10.6), two distance sensors for speed measurement (10.1).

By means of the spring-actuated universal impact test device, the impact trolley (1) will reach a certain speed and energy level proportional to the energy stored in the traction springs (2.1) and the weight of the impact trolley (1). The traction springs (2.1) provide the drive to accelerate the impact trolley (1). The impact trolley (1) will reach the prescribed velocity and energy and impact the test specimen, during this collision, the impact load-time, acceleration-time and velocity data of the impact trolley (1) just before the collision will be collected.

The advantages obtained with the developed spring-actuated universal impact test device are listed below.
It provides the opportunity to apply impact in the horizontal plane.
Easy specimen mounting is provided.
Different test parameters such as speed, weight, contact surface geometry and contact stiffness can be used.
The impact test device can be easily manufactured in different sizes and capacities, installed or relocated after installation.

The developed impact test device includes solutions for setting up the rails, tensioning and launching the weight, applying impact by impacting the weight to the targeted object in predictable and different ways, and measuring the applied impact effects. In addition, the impact test device allows easy diversification of the test parameters of speed, weight, contact surface geometry and contact stiffness in the impact load to be applied according to the user's demand.

The impact contact surface geometry and stiffness parameters are provided by connecting materials of different geometry and elastic properties to the load sensor (1.6) connected to the impact trolley (1).

Specimen mounting diversity is provided by the specimen main mounting frame (7) connected to the linear motion frame (10). Thanks to the gaps on the specimen main mounting frame (7), specimen mounting can be provided in many ways from both sides. The three-point loading system (8), which can be used in materials testing, is an example of this mounting diversity.

The hook and spring tensioning system (3) comprises at least one release hook (3.2) pivotable around an attachment point, holding the hook holding knob (1.2) at one end and accommodating an interaction surface at the other end. The spring tensioning distance adjustment and unhooking system (4) comprises at least one bearing (4.1) which, by pressing the interaction surface, forces the release hook (3.2) to rotate around the attachment point so as to release the hook holding knob (1.2).

In a preferred embodiment of the invention, the attachment point defines an axis of rotation perpendicular to the direction of movement of the impact trolley (1) and the release hook (3.2) releases the hook holding knob (1.2) as a result of movement of the release hook (3.2) and the bearing (4.1) relative to each other along said direction. This movement, which releases the hook holding knob (1.2), can be performed by executing the bearings (4.1) after tensioning the traction springs (2.1) to the desired level, or preferably by executing the hook and spring tensioning system (3) after positioning the bearings (4.1) with the fixing frame (4.6) so as to correspond to the position where the traction springs (2.1) are to be tensioned to the desired level.

What is claimed is:

1. A spring-actuated universal impact test device, comprising;
an impact trolley, wherein sensors comprising acceleration and load are allowed to be connected to the impact trolley, with a first weight providing an impact load,
a spring-loaded launching system with tension springs for launching the impact trolley,
a hook and spring tensioning system in connection with the impact trolley for tensioning the tension springs,
a spring tensioning distance adjustment and unhooking system, wherein the spring tensioning distance adjustment and unhooking system allows a tensioning distance of the tension springs to be adjusted and a release hook holding the impact trolley at the tensioning distance to release the impact trolley,
an impact absorber system for stopping a push trolley, wherein the impact absorber system transfers a drive provided by the tension springs to the impact trolley, wherein the push trolley disengages from the impact trolley after a predetermined distance,
wheel rails for bearing moving components and derailment barriers for preventing the impact trolley from exiting the wheel rails,
a specimen main mounting frame, wherein the specimen main mounting frame allows specimens to be fixed in various manners,
an anti-kickback apparatus with a second weight to prevent kickback during operation,
wherein the spring-actuated universal impact device comprises;
at least one release hook pivoting around an attachment point on the hook and spring tensioning system, holding a hook holding knob with a first end and accommodating an interaction surface at a second end,
at least one bearing in the spring tensioning distance adjustment and unhooking system, wherein the at least one bearing, by pressing on the interaction surface, forces the at least one release hook to rotate around the attachment point to release the hook holding knob.

2. The spring-actuated universal impact test device according to claim 1, wherein the spring-actuated universal impact test device comprises at least one closing spring, wherein the at least one closing spring compresses the release hook to engage the hook holding knob.
